(19) United States
(12) Patent Application Publication
(10) Pub. No.: US 2014/0309357 A1
(43) Pub. Date: Oct. 16, 2014

(54) Hydrophobic Polymers

(71) Applicant: Nutripol Capital S.a r.l., Luxembourg (LU)

(72) Inventor: Mustafa Kaya, Luxembourg (LU)

(73) Assignee: Nutripol Capital S.a r.l., Luxembourg (LU)

(21) Appl. No.: 14/253,202

(22) Filed: Apr. 15, 2014

(30) Foreign Application Priority Data
Apr. 15, 2013 (NL) 2010639

(51) Int. Cl. C08L 33/02; C09D 5/00

(52) U.S. Cl. CPC C08L 33/02; C09D 5/00
USPC 524/503; 525/57

(57) ABSTRACT

The present invention relates to hydrophobic, or water resistant or water repellant, polymers and especially to hydrophobic, or water resistant or water repellant, biodegradable polymers. Preferred polymers according to the present invention are polymers based on polylactic acid, polyvinyl, starch, polyacrylic acid, polyester and polymers based on combinations thereof. Further, the present invention relates to novel additives and techniques to provide polymers, and especially biodegradable polymers, with improved hydrophobic, water-repellent or water resistant properties.

### CROSS-REFERENCE TO RELATED APPLICATION

This application claims priority to Netherlands Patent Application No. 2010639 filed Apr. 15, 2013, the disclosure of which is hereby incorporated by reference in its entirety.

### FIELD OF THE INVENTION

The present invention relates to hydrophobic, or water resistant or water repellant, polymers and especially to hydrophobic, or water resistant or water repellant, biodegradable polymers. Preferred polymers according to the present invention are polymers based on polylactic acid, polyvinyl, starch, polyacrylic acid, polyester and polymers based on combinations thereof. Further, the present invention relates to novel additives and techniques to provide polymers, and especially biodegradable polymers, with improved hydrophobic, water-repellent or water resistant properties.

### BACKGROUND OF THE INVENTION

Compostable polymers such as biopolymers and biodegradable polymers have an inherent tendency to swell or to absorb, in some cases, significant amounts of water. However, water absorption is for many applications a non-desirable characteristic and, accordingly, water absorption limits the number of applications for which biodegradable polymers can suitably be used.

For example, because of an inherent hydrophilic character of biodegradable polymers, i.e. water absorption is an import factor determining biodegradability, these polymers have a tendency to migrate into food or into a surface when they become in contact with water or moisture. Further, water absorption characteristics can negatively influence the durability, or life-time, of products made from biodegradable polymers.

Although a number of additives decreasing the water absorption are known, either the added value of these additives is limited or these additives have a negative contribution to the overall biodegradability of the resulting polymer.

Accordingly, there is a general need in the art of polymers to provide further additives capable of decreasing the water absorption of polymers. Formulated, differently, there is a general need in the art of polymers to increase the hydrophobicity, or water-repelling characteristics, of polymers, and especially biodegradable polymers.

Considering the above, it is an object of the present invention, amongst other objects, to provide means for increasing the hydrophobicity of polymers and especially biodegradable polymers.

It is a further object of the present invention, amongst other objects, to provide polymers, and especially biodegradable polymers, with an increased hydrophobicity allowing to use the present polymers for a wide range of applications.

At least part of the above objects, if not all, are met by the present invention by providing an hydrophobic polymer as defined in the appended claims.

### SUMMARY OF THE INVENTION

Specifically, at least part of the above objects, if not all, are met by the present invention by providing hydrophobic polymers obtainable by a method comprising:
a) preparing a mixture of monomers and/or polymers thereby forming a polymeric mixture; and
b) crosslinking said polymeric mixture in the presence of one or more lower oligosaccharides, preferably di- or trisaccharides, at a pH between 1.5 and 6 and a temperature of 60° C. to 160° C. thereby providing a crosslinked polymeric mixture;
   wherein:
1) in step (a) a compound selected from the group consisting of polyisobutylene (PIB), hydroxymethylfural (HMF) and 2,5-dimethylfuran (DMF) is added to the polymeric mixture; or
2) after step (b) a compound selected from the group consisting of polyisobutylene (PIB), hydroxymethylfural (HMF) and 2,5-dimethylfuran (DMF) is contacted with the crosslinked polymeric mixture.

### DESCRIPTION OF THE INVENTION

The present inventor has surprisingly found that incorporating, as additives, polyisobutylene with the formula (C₄H₈)n and/or HMF (hydroxymethylfural with the formula C₆H₆O₃) and/or DMF (2,5-Dimethylfuran with the formula (CH₃)₂C₄H₂O), into polymers, for example by adding or coating, significantly increases the hydrophobicity, or decreases the hydrophylicity, of these polymers.

The present additives can be, for example, be added or coated dissolved in an appropriate solvent, they can directly be added or mixed into polymeric compounds, they can be added by side feeding into, for example, an extruder or they can be (spray)coated onto a polymer.

Appropriate solvents for the present additives include oils such as rapeseed oil, olive oil, caraway oil, soy oil, walnut oil, hazelnut oil, peanut oil or peanut butter, coconut butter, lemon oil, sheep fat, beef fat, and fish oil and hydrocarbon solvents, such as a blend of hydrocarbon solvent sold under the trademark shellsol D100®, naphthenes, paraffin, aromatic hydrocarbons, halogenated hydrocarbons, and aliphatic, aromatic or cyclic hydrocarbons. Preferred solvents are C₅-C₁₀ saturated hydrocarbons because they readily dissolve polyisobutylene (PIB) at temperatures between 80 to 160° C.

According to the present invention polyisobutylene (PIB) preferably has a molecular weight between 50,000 to 100,000 or higher. The polyisobutylene (PIB) according to the present invention can be hydrogenated for improving the solubility thereof.

Hydrogenation can, for example, be provided by first oxidizing polyisobutylene (PIB) using, for example, nitric acid, hydrogen peroxide or another oxidizing agent and subsequently hydrogenating polyisobutylene (PIB) using a hydrogen-bond donor such as sulphonic acid, carboxylic acid, alcohol, phosphorous acid, phosphoric acid esters, sulfuric acids or phenols.

According to the present invention, the pH of the crosslinking reaction is in the range of 1.5 to 6. This pH range can suitably be provided by adding an acid to the polymeric mixture such as sulfuric acid.

Within the context of the present invention, the addition of further additives improving the hydrophobicity to the polymeric composition is contemplated such as the addition of gallic acid, methylgallate, fluoropolymers, aluminum stearate and/or calcium stearate.

The present inventor also surprisingly found that the present additives, i.e. polyisobutylene (PIB), hydroxymethylfural (HMF) and 2,5-dimethylfuran (DMF), besides improving the hydrophobicity, also contribute to the fire retardation characteristics of the resulting crosslinked polymeric mixture.

According to a preferred embodiment of this first aspect of the present invention, the present hydrophobic polymers are obtainable by a method wherein:
1) in step (a) a hydrocarbon solvent or a vegetable or mineral oil is further added to the polymeric mixture; or
2) after step (b) said compound selected from the group consisting of polyisobutylene (PIB), hydroxymethylfural (HMF) and 2,5-dimethylfuran (DMF) is further dissolved in a hydrocarbon solvent or a vegetable or mineral oil.

According to another preferred embodiment of this first aspect of the present invention, the present hydrophobic polymers are obtainable by a method wherein in step (a) one or more oxygen donors are added to the polymeric mixture, said oxygen donors are preferably selected from the group consisting of hydrogen peroxide, ozone and nitric oxide.

According to yet another preferred embodiment of this first aspect of the present invention, the present hydrophobic polymers are obtainable by a method wherein in step (a) one or more hydrogen-bond donors are added to the polymeric mixture, said hydrogen-bond donors are preferably selected from the group consisting of sulphonic acid, carboxylic acid, alcohol, phosphorous acid, phosphoric acid ester, sulfuric acid and phenol.

According to still another preferred embodiment of this first aspect of the present invention, the present hydrophobic polymers are obtainable by a method wherein in step (a) are further added to the polymeric mixture sodium ions, preferably sodium silicate and/or sodium oxide.

According to an especially preferred embodiment of the present invention, the present polymeric mixture comprises polymers selected from the group consisting of polyacrylic acid (PAA), polylactic acid (PLA), polyvinyl based polymers, polyvinyl alcohol (PVOH) and starch, preferably a polymeric mixture comprising polyacrylic acid (PAA) and polyvinyl alcohol (PVOH).

According to another especially preferred embodiment of the present invention, the present hydrophobic polymers are obtainable by a method wherein step (a) comprises:
a1) preparing an acidic mixture of polyacrylic and/or polyaspartic acid, sodium ions, one or more oligosaccharides and water, wherein the resulting mixture has a pH equal to or lower than 5;
a2) maintaining the temperature of said acidic mixture in a range of from 80° C. to 130° C. until an homogeneous suspension is obtained; and
a3) adding polyvinyl alcohol (PVOH) and one or more polycarboxylic acids to the mixture of step (b) while maintaining the temperature in a range of from 80° C. to 130° C. thereby forming a crosslinked polymeric mixture.

In the present polymeric mixture the amounts of polyisobutylene (PIB), hydroxymethylfural (HMF) or 2,5-dimethylfuran (DMF) are preferably in the range of 0.5 to 60 weight percent (wt %) as compared to the weight of the polymeric mixture

According to the present invention the pH of the polymeric mixture of step (a) preferably is in the range of 1 to 4.5, more preferably 3.5 to 4.

According to the present invention, the present oligosaccharides are preferably selected from the group consisting of sucrose, maltose, lactose, nigerotriose, maltrotriose, melezitose, sugar alcohols, mannitol, sorbitol, xylitol, maltitol and lactitol, preferably sucrose.

According to the present invention, the present hydrophobic polymers are preferably obtainable using a di- or tricarboxylic acid chosen from the group consisting of citric acid, isocitric acid, aconitic acid, tricarballylic acid, succinic acid, maleic acid, citrofol a1 and citrofol b1, preferably citric acid and/or citrofol b1.

According to a second aspect, the present invention relates to the use of a compound selected from the group consisting of polyisobutylene (PIB), hydroxymethylfural (HMF) and 2,5-dimethylfuran (DMF) for increasing the hydrophobicity of a polymer.

According to a third aspect, the present invention relates to the use of the present hydrophobic polymers for coating surfaces, as a protective layer, for thermal insulation, for anti-oxidation insulation, for the manufacture of packaging materials, the manufacture of food containers, the manufacture of food protective films, or for carpeting floor or walls.

### BRIEF DESCRIPTION OF THE DRAWINGS

The present invention will be further illustrated and detailed using examples of preferred embodiments. In the examples, reference is made to figures wherein:

FIG. 1: shows a graphic representation of the water absorption characteristic of the present polymers (LT4 to LT20) as compared to polymers without the present additives (LT1 to LT3) after 24 hours;

FIG. 2: shows a graphic representation of the water absorption characteristic of the present polymers (LT4 to LT16) as compared to polymers without the present additives (LT1 to LT3) after 48 hours;

### EXAMPLES

### Example 1

### General Preparation of Samples

A premix A was prepared of
   Shellsol D100 or an oil;
   Nitric acid or sulphuric acid;
   Hydrogen peroxide; and
   non-stabilized polyisobutylene.
The above premix A was mixed at temperatures between 60 to 160° C. until the polyisobutylene was dissolved.

A premix B was prepared of:
Polyacrylic acid;
Demineralized water;
PVOH;
Sucrose;
NaOH;
H₂SO₄ (optional); and
Sodium silicate (optional)
The pH of the above premix B as adjusted to a pH smaller than 5 or less

Subsequently, premix A and premix B were combined at a temperature of between 80 and 160° C. and mixed at maximum speed with a IKA Eurostar, power control-visc P1 until a crosslinked polymeric mixture was obtained.

When a hydrogenated polyisobutylene is used instead of non-stabilized polyisobutylene, nitric acid and hydrogen peroxide can be omitted from premix A.

The crosslinked polymeric mixture can be casted, extruded or sprayed. The drying of the crosslinked polymeric mixture can be by infrared or by temperature.

### Examples 2 to 11

Comparative examples LT1 to LT3 and examples LT4 to LT20 were prepared as follows using the protocol of example 1:

TABLE 1
Polymer compositions

| | LT1 | LT2 | LT3 | LT4 | LT9 | LT11 | LT13 | LT15 | LT16 | LT18 | LT20 |
|---|---|---|---|---|---|---|---|---|---|---|---|
| Polyacrylic acid | 100 | 100 | 100 | 100 | 100 | 100 | 100 | 100 | 100 | 100 | 100 |
| Water | 100 | 300 | 200 | 200 | 200 | 200 | 200 | 200 | 200 | 200 | 200 |
| Sucrose | 15 | 15 | 15 | 15 | 15 | 15 | 15 | 15 | 15 | 15 | 15 |
| Polyvinyl-alcohol | 25 | 45 | 30 | 30 | 30 | 30 | 30 | 30 | 30 | 30 | 30 |
| H₂SO₄ | | 5 | 6 | 7 | | | 7 | 7 | | 10 | 10 |
| Sodium silicate | | | 0.95 | 1 | 0.2 | 0.2 | 0.5 | 0.5 | 0.5 | | |
| Polyiso-butylene | | | | 3 | 1 | 3 | 15 | 15 | 20 | 3* | 3 |
| Solvent* | | | | 3 | 30 | 15 | 20 | 20 | 20 | | |
| Oil | | | | | | | | | | 3 | 6 |

*Hydrocarbon solvent (shellsol D100)

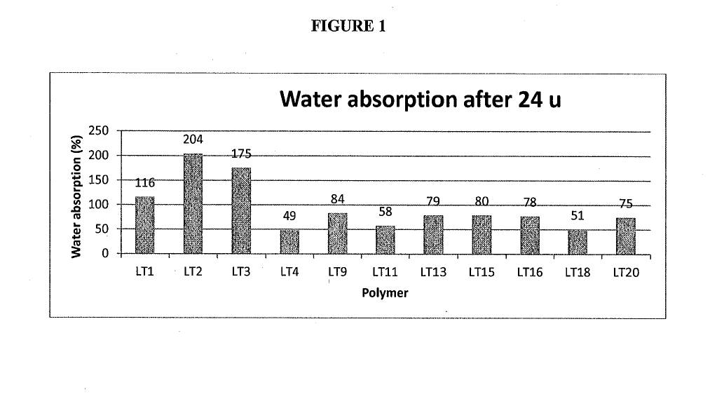

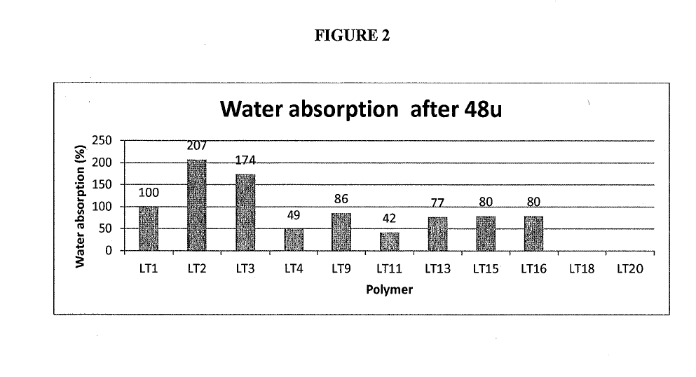

Subsequently the water absorption characteristics of the resulting crosslinked polymeric mixtures was determined after 24 hours and 48 hours. The results obtained are presented in Table 2 and FIG. 1 (24 hours) and Table 2 and FIG. 2 (48 hours)

TABLE 2
Hydrophobicity expressed in percentage water absorption

| | LT1 | LT2 | LT3 | LT4 | L19 | LT11 | LT13 | LT15 | LT16 | LT18 | LT20 |
|---|---|---|---|---|---|---|---|---|---|---|---|
| Mass (g) | 1.44 | 0.68 | 1.62 | 0.8 | 1.22 | 1.25 | 2.2 | 1.52 | 0.98 | 1.04 | 2.03 |
| Mass (g) | 3.11 | 2.07 | 4.46 | 1.19 | 2.24 | 1.98 | 3.94 | 2.73 | 1.74 | 1.57 | 3.56 |
| 24 hours | | | | | | | | | | | |
| Water | 116 | 204 | 175 | 49 | 84 | 58 | 79 | 80 | 78 | 51 | 75 |
| absorption | | | | | | | | | | | |
| (%) | | | | | | | | | | | |
| Mass (g) | 2.88 | 2.09 | 4.44 | 1.19 | 2.27 | 1.77 | 3.89 | 2.73 | 1.76 | | |
| 48 hours | | | | | | | | | | | |

As shown in the Table 2 and FIGS. 1 and 2, adding the present additives enhanced the hydrophobicity of the crosslinked polymeric mixture in comparison to the comparative examples.

1. Hydrophobic polymer obtainable by a method comprising:
a) preparing a mixture of monomers and/or polymers thereby forming a polymeric mixture; and
b) crosslinking said polymeric mixture in the presence of one or more lower oligosaccharides, preferably di- or trisaccharides, at a pH between 1.5 and 6 and a temperature of 60° C. to 160° C. thereby providing a crosslinked polymeric mixture;
wherein:
1) in step (a) a compound selected from the group consisting of polyisobutylene (PIB), hydroxymethylfural (HMF) and 2,5-dimethylfuran (DMF) is added to the polymeric mixture; or 2) after step (b) a compound selected from the group consisting of polyisobutylene (PIB), hydroxymethylfural (HMF) and 2,5-dimethylfuran (DMF) is contacted with the crosslinked polymeric mixture.

2. Hydrophobic polymer according to claim 1, wherein
1) in step (a) a hydrocarbon solvent or a vegetable or mineral oil is further added to the polymeric mixture; or
2) after step (b) said compound selected from the group consisting of polyisobutylene (PIB), hydroxymethylfural (HMF) and 2,5-dimethylfuran (DMF) is further dissolved in a hydrocarbon solvent or a vegetable or mineral oil.

3. Hydrophobic polymer according to claim 1, wherein in step (a) one or more oxygen donors are added to the polymeric mixture, said oxygen donors are preferably selected from the group consisting of hydrogen peroxide, ozone and nitric oxide.

4. Hydrophobic polymer according to claim 1, wherein in step (a) one or more hydrogen-bond donors are added to the polymeric mixture, said hydrogen-bond donors are preferably selected from the group consisting of sulphonic acid, carboxylic acid, alcohol, phosphorous acid, phosphoric acid ester, sulphuric acid and phenol.

5. Hydrophobic polymer according to claim 1, wherein in step (a) are further added to the polymeric mixture sodium ions, preferably sodium silicate and/or sodium oxide.

6. Hydrophobic polymer according to claim 1, wherein said polymer is selected from the group consisting of polyacrylic acid (PAA), polylactic acid (PLA), polyvinyl based polymers, polyvinyl alcohol (PVOH) and starch.

7. Hydrophobic polymer according to claim 1, wherein said polymeric mixture comprises polyacrylic acid (PAA) and polyvinyl alcohol (PVOH).

8. Hydrophobic polymer according to claim 1, wherein step (a) comprises:
a1) preparing an acidic mixture of polyacrylic and/or polyaspartic acid, sodium ions, one or more oligosaccharides and water, wherein the resulting mixture has a pH equal to or lower than 5;
a2) maintaining the temperature of said acidic mixture in a range of from 80° C. to 130° C. until an homogeneous suspension is obtained; and
a3) adding polyvinyl alcohol (PVOH) and one or more polycarboxylic acids to the mixture of step (b) while maintaining the temperature in a range of from 80° C. to 130° C. thereby forming a crosslinked polymeric mixture.

9. Hydrophobic polymer according to claim 1, wherein said compound selected from the group consisting of polyisobutylene (PIB), hydroxymethylfural (HMF) and 2,5-dimethylfuran (DMF) is added in an amount of 0.5 to 60 weight percent (wt %) of the polymeric mixture

10. Hydrophobic polymer according to claim 1, wherein the pH of the polymeric mixture of step (a) is in the range of 1 to 4.5, more preferably 3.5 to 4.

11. Hydrophobic polymer according to claim 1, wherein said one or more oligosaccharides are selected from the group consisting of sucrose, maltose, lactose, nigerotriose, maltrotriose, melezitose, sugar alcohols, mannitol, sorbitol, xylitol, maltitol and lactitol, preferably sucrose.

12. Hydrophobic polymer according to claim 1, wherein the polycarboxylic acid is a di- or tricarboxylic acid chosen from the group consisting of citric acid, isocitric acid, aconitic acid, tricarballylic acid, succinic acid, maleic acid, citrofol a1 and citrofol b1, preferably citric acid and/or citrofol b1.

13. Hydrophobic polymer according to claim 1, wherein the polymeric mixture of step (a) further comprises one or more vegetable and/or animal oils and/or fats selected from the group consisting of rapeseed oil, olive oil, caraway oil, soy oil, walnut oil, hazelnut oil, peanut oil or peanut butter, coconut butter, lemon oil, sheep fat, beef fat, and fish oil.

14. A method of increasing the hydrophobicity of a polymer comprising incorporating into a polymer a compound selected from the group consisting of polyisobutylene (PIB), hydroxymethylfural (HMF) and 2,5-dimethylfuran (DMF).

15. A method of coating a surface, comprising applying the hydrophobic polymer according to claim 1 to a surface as a protective layer, for thermal insulation, for anti-oxidation insulation, for the manufacture of packaging materials, the manufacture of food containers, the manufacture of food protective films, or for carpeting floor or walls.
